(19) United States
(12) Patent Application Publication
(10) Pub. No.: US 2003/0010608 A1
(43) Pub. Date: Jan. 16, 2003

(54) Skid conveyor

(76) Inventor: John H. Jaynes, Commerce, MI (US)

Correspondence Address: Douglas A. Mullen, Dickinson Wright PLLC, Suite 800, 1901 L. Street NW, Washington, DC, 20036, US

(21) Appl. No.: 10/122,259

(22) Filed: Apr. 12, 2002

Related U.S. Application Data
(60) Provisional application No. 60/304,112, filed on Jul. 11, 2001.

(51) Int. Cl. B65G 21/00

(52) U.S. Cl. 198/860.1

(57) ABSTRACT

A conveyor, preferably for transporting skids, including a frame having first and second laterally spaced side rails, first and second underlayments fixed to the first and second side rails, first and second endless belts, and a drive mechanically coupled to the first and second belts. The belts are formed of a plurality of interconnected rigid modules wherein the first underlayment supports the first belt and the second underlayment supports the second belt.

### CROSS-REFERENCE TO RELATED APPLICATION

This application claims the benefit of U.S. Provisional Application No. 60/304,112, filed Jul. 11, 2001, the entire disclosure of the application is considered part of the disclosure of this application and is hereby incorporated by reference.

### BACKGROUND OF THE INVENTION

The present invention relates to material handling conveyor systems and, more particularly, to a conveyor that uses spaced and parallel drive belts to convey an article on a skid.

Over the years, the material handling industry has developed a number of conveyor designs that are suitable for a variety of applications but particularly useful for one or more specific tasks. One example of such a conveyor is what has become known as a skid conveyor, commonly used in automobile assembly applications. A skid is a carrier or support frame that includes laterally spaced and parallel rails. An automobile body is coupled to the skid for transportation through assembly processes.

Traditionally, a skid conveyor includes rollers or spaced apart friction-driven belts that support and convey the skid by direct engagement with the skid rails. Skid conveyors that use rollers to move and support the skid generally include a plurality of cylindrical rollers that are oriented transversely to the direction of skid movement and rotated by a drive assembly. The skid is transported along the table by engagement with the rotating rollers. Roller tables, while generally suitable for their intended purpose, suffer certain drawbacks. For example, unless the rollers are precisely vertically aligned, the transported skid tends to undergo slight vertical displacement as the skid moves from roller to roller. This rocking can cause instability and increased noise.

A second common skid conveyor uses a pair of endless belts that each extend the longitudinal length of the conveyor and that are laterally spaced from one another to match the spacing of the skid rails. Each of the skid rails ride on one of the correspondingly spaced belts. The belts are commonly driven by frictional engagement with pulleys mounted on a rotating shaft. In order to move the skids in proper orientation, the belts must move as the same speed. Unfortunately, difficulties in properly tensioning the drive belts, belt slippage, and lengthening of the belts over time makes it difficult to effectively synchronize the belt movement. Moreover, the pulleys tend to have large diameters in order to provide a sufficient area of frictional engagement between each pulley and belt. Accordingly, if it is desired to position the skids at or close to the surrounding floor, the conveyor is often required to be disposed in a pit. Further, friction driven belts are commonly formed of a flexible material so that the belt forms a smooth radius around the pulley. Thus, most skid conveyor belts are formed of a material, such as a woven cloth or relatively soft rubber, that does not effectively withstand the operational forces generated by the repeated loading and unloading of non-uniform skid rails. Yet another disadvantage of skid conveyors using friction driven belts is that if a belt section is damaged or otherwise in need of replacement, the entire belt must be removed and replaced.

U.S. Pat. No. 6,176,367 is representative of a prior art skid conveyor having a pair of laterally spaced belts each with a grooved surface that cooperates with toothed idling pinions located at the downstream end of the conveyor and toothed drive pinions disposed at the upstream end of the conveyor. The drive pinions are driven by a transverse shaft and a tensioning device is provided to permit adjustment of the belt operating tension. The conveyor also includes toothed supporting rollers and shoes arranged in an intermediate position between the supporting rollers so that the belt position is free to deviate slightly at the supporting rollers but is brought back to the central position by the action of the guide shoes. The purported advantages of the conveyor described in the '367 patent include “soft” coupling of the skid and belt due to the elevated height of the support rollers relative to the drive and idler pinions, a reduction in noise resulting from the toothed projections on the support rollers, and the guiding of the belt by the shoes in areas where the belt is not subjected to the forces of the supporting rollers.

While the '367 patent attempts to address several deficiencies in the skid conveyor art, the conveyor described therein includes numerous drawbacks. For example, the use of spaced supporting rollers cause discrete areas of lateral belt movement and corresponding stresses. While the shoes are intended to minimize the effect of these forces, the presence of the forces are nonetheless undesirable. Further, the lack of a continuous support surface for the belt reduces the stability of the skid during transport. Yet another disadvantage is the need to continually adjust the tension of the belt such as through the tensioning device. As the belt elongates during use, the distance between the grooves on the belt also lengthen which tends to cause misalignment with the pinion teeth. Other disadvantages of prior art skid conveyors will be apparent from the following description of the present invention.

### SUMMARY OF THE INVENTION

With the above in mind, the present invention is directed to a conveyor, preferably for transporting skids, that includes a frame having first and second laterally spaced side rails, first and second underlayments fixed to the first and second side rails, first and second endless belts and a drive mechanically coupled to the first and second belts. The belts are formed of a plurality of interconnected rigid modules wherein the first underlayment supports the first belt and the second underlayment supports the second belt.

Further scope of applicability of the present invention will become apparent from the following detailed description, claims, and drawings. However, it should be understood that the detailed description and specific examples, while indicating a preferred embodiment of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a top plan view of a skid conveyor according to the present invention;

FIG. 2 is a side elevation view of the skid conveyor shown in FIG. 1 with skids and workpieces on the conveyor;

FIG. 3 is a sectional view taken along the line 3-3 shown in FIG. 1;

FIG. 4 is a cross-sectional view of a modified belt upper surface profile;

FIG. 5 is a top plan view of a belt section illustrating the modular nature thereof;

FIG. 6 is a cross-sectional illustration of an alternative belt and underlayment configuration providing lateral restraint of the belt along its longitudinal path;

FIG. 7 is a side elevational view of a portion of a representative drive assembly having a drive shaft with at least one sprocket longitudinally fixed to the shaft for engagement with each belt;

FIG. 8 is a side elevational view of an alternate embodiment of the present invention wherein a reversible drive assembly is included to move the belt in two directions;

FIG. 9 is a top plan view of an alternative belt configuration having an accumulator assembly; and

FIG. 10 is a side elevational view of the belt illustrated in FIG. 9.

### DETAILED DESCRIPTION OF THE PREFERRED EMBODIMENT

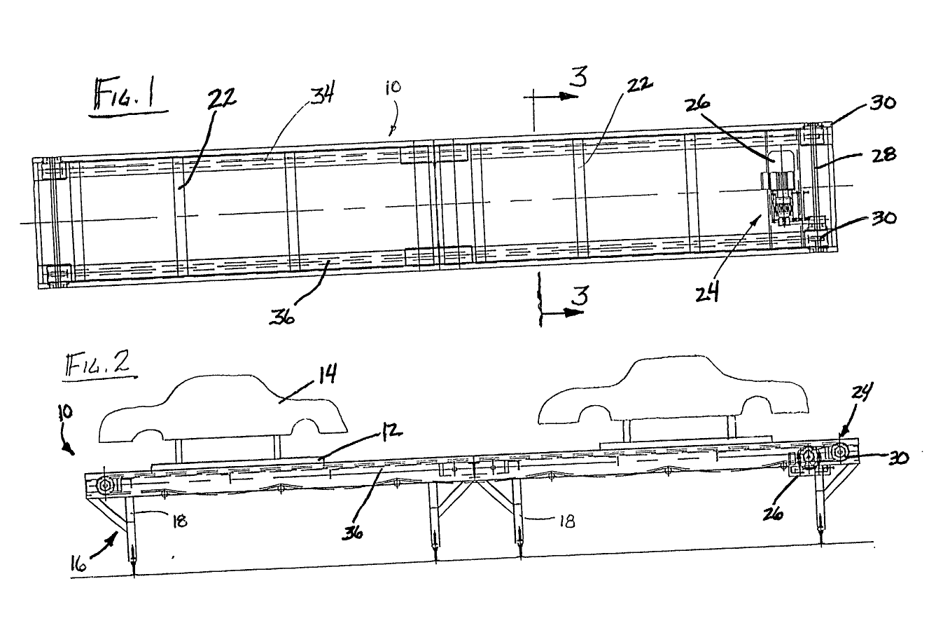

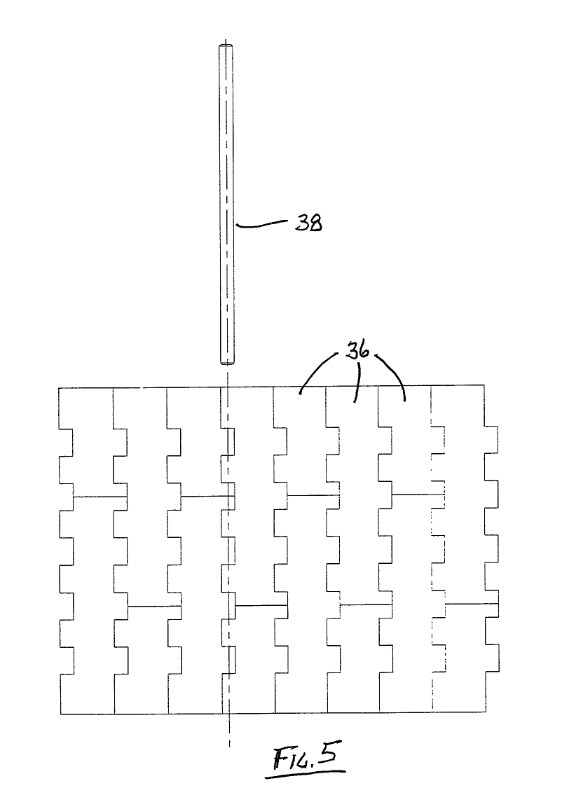

FIGS. 1-3 illustrate a skid conveyor 10 for transporting a plurality of skids 12 with workpieces 14, such as the illustrated vehicle body, attached thereto. The conveyor 10 includes a frame 16 with supporting legs 18, side rails 20 (FIG. 3), and cross members 22. It should be appreciated that a variety of frame configurations may be used without departing from the scope of the present invention. By way of example rather than limitation, the legs 18 may be eliminated to lower the conveyor profile. Moreover, the conveyor 10 may be used in a variety of assembly processes including placing a number of conveyors 10 in series so as to pass the conveyed articles along an extended path.

The conveyor 10 also includes a drive assembly 24 fixed to the frame 16. The drive assembly includes a drive motor 26 coupled to rotate a drive shaft 28. Toothed sprockets 30 are coupled to rotate with the shaft 28 and mechanically engage the first and second belts 32 and 34 which are laterally spaced from, and parallel to, one another. The use of a mechanical engagement rather than frictional coupling of the belt and sprockets provide numerous advantages including positively indexing the spaced belts to one another to ensure coordinated movement, more efficient power transfer between the shaft and belt, and permitting the diameter of the sprockets to be reduced relative to friction drives thereby minimizing the necessary vertical height of the conveyor in low profile applications.

The skid rails passed to the belts often have non-uniform characteristics that tend to wear the belts and other conveyor components. Accordingly, for even greater effectiveness relative to the prior art, the belts of the present invention are preferably comprised of a rigid plastic material having sufficient hardness and durability to effectively receive and transport the skids over an extended period of time. The upper engagement surface 38 of the belts, while illustrated in FIG. 3 as a substantially flat surface, may have a variety of different configurations or additional components to enhance the operational capabilities of the invention. For example, the engagement surface of the belts may be provided with wear pads to increase their durability and/or a concave configuration (FIG. 4) to assist in retaining and/or centering the skid rails on the belts if desired.

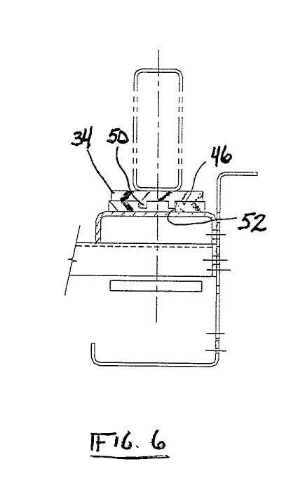

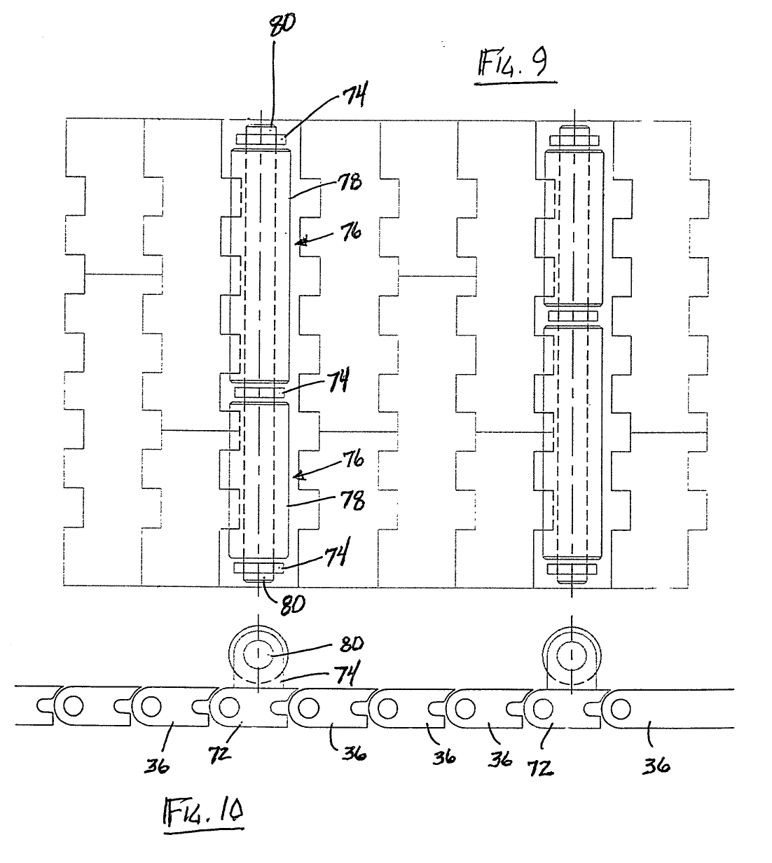

As is best illustrated in FIGS. 5, 6, 9, and 10, the belts 32 and 34 are each preferably formed of a plurality of modules or links 36 formed of a rigid and impact resistant plastic. Each module 36 is configured to mesh with adjoining modules and are coupled to one another by a hinge or pin 38 to form an endless, modular, and hinged belt (FIG. 5). This configuration facilitates the mechanical coupling of each belt segment to the toothed drive sprockets in a manner that ensures the proper indexing of the separate belts to one another. The hinged coupling of the rigid modules permits the belts to be manufactured of sufficiently rigid and impact resistant material to withstand the significant loadings present in the contemplated environment while presenting chorded curves that pass about the toothed sprockets. The rigid nature of the belts facilitate load transfer to the low friction underlayment 40 (FIG. 3) and the support frame side rails thereby further enhancing the performance of the present invention.

Those skilled in the art will appreciated that the composition of the belts, low friction underlayments, and other conveyor components may vary based upon the performance criteria for a particular application. However, it is generally desirable that the belts and low friction underlayment exhibit a good balance of mechanical, thermal, and chemical properties suitable for the loading and environmental conditions present in automobile assembly operations.

Mechanical properties of particular interest include strength, durability, and impact resistance so that the belts and underlayment are capable of withstanding the repeating impact of heavy skids being transferred onto and conveyed by the belts. Further, the friction factor of the belts and underlayments impact the power requirements of the drive assembly 24. The underlayments 40 provide substantially continuous support for the belts 32 and 34 in order to effectively distribute loadings to the frame, minimize the frictional forces created by the moving belt, and otherwise enhance the performance of the conveyor in high loading applications such as those described herein.

In many automotive applications, conveyors are used to transport skid supported vehicles through a variety of treatment processes where the chemical and thermal environment are of concern. By way of example, vehicle body painting processes subject the vehicle to cleaning and paint preparation solutions that may adversely impact certain belt material. This impact may result even when the belts themselves are not passed directly through these environments. When a belt conveyor of the type described herein follows a chemical or thermal treatment process, residue of the chemical or undissipated temperature extremes may remain on the skid or vehicle passed to the conveyor. Thus, it is desirable that the belts and associated components exhibit appropriate chemical and thermal characteristics and that the overall conveyor design is resistant to such environmental factors.

Belts, underlayment, sprockets, drive shafts, and other accessories suitable for use with the conveyor 10 are generally known and available in the art. For example, Intralox, Inc. of Harahan, La. and Uni-chains Manufacturing Inc. of Redding, Pa. currently manufacture and distribute modular plastic belting and other conveyor components that may be used with the conveyor 10. It is specifically contemplated that polypropylene, polyethylene, and acetal thermoplastics may be particularly suitable for belts in the present invention and that an Intralox Series 1400 Flat Top acetal thermoplastic belt having a width of approximately four and one-half inches is particularly suitable for use with the conveyor 10. However, those skilled in the art will appreciate from this description that a variety of different belt compositions and configurations may be used without departing from the scope of the invention as defined by the appended claims. A variety of factors such as conveyor load capacity, belt tension, power requirements, and component compatibility will impact the proper selection of conveyor components.

By way of example, the underlayment 40 may be formed of a variety of materials and in a variety of configurations. Each underlayment preferably provides sufficient structural support for the belts 30 and 32, transfer loadings to the frame, and present a sufficiently low friction factor relative to the moving belt to satisfy the power requirements of the conveyor. The underlayment 40 may be formed of a variety of low friction materials such as nylon, HDPE, stainless steel, carbon steel, or the like. It has been determined that the conveyor of the present invention performs in a satisfactory manner with an underlayment 40 formed of an ultrahigh molecular weight (UHMW) sheet creating a friction factor of less than about 0.20, preferably less than 0.18, and, even more preferably, about 0.10 or less between the belt and underlayment. The distance between the lateral sides 42 of the underlayment is preferably no less than the width of each belt (FIG. 3).

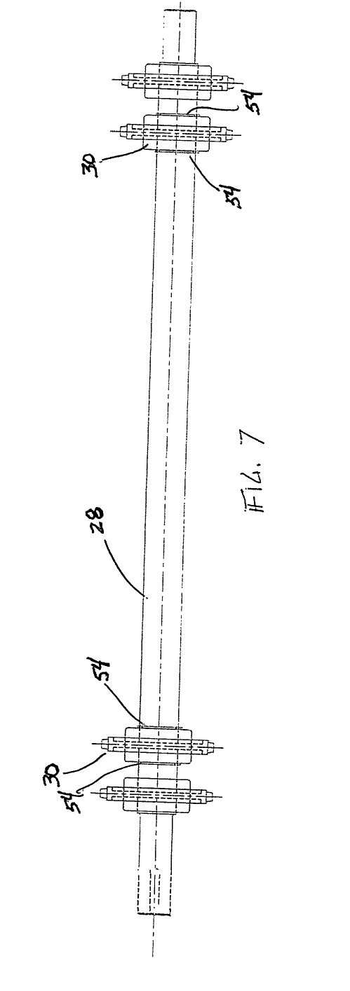

The underlayments 40 and belts 32 and 34 may also have a variety of cross sectional configurations. For example, while the lower surfaces 46 of the belts include upwardly extending recesses to cooperate with the teeth on the sprockets as is generally known in the art, the lower belt surfaces 46 and the upper surfaces 48 of the underlayments may be substantially planar as shown in FIG. 3 or may include cooperating projection(s) 50 and recess(es) 52 as shown in FIG. 6. In the first instance, the belt/underlayment interengagement does not prevent lateral movement of the belts relative to the underlayment. In order to limit such movement, the longitudinal position of at least one of the sprockets 30 engaging each belt is preferably fixed relative to the drive shaft such as by locking rings 54 (FIG. 7). Frame components or guiding shoes may also be used to restrict lateral movement of the belts. In the second instance, the belt is provided with single or multiple sets of downwardly extending projections 50 and the underlayment 40 includes a tracking recess 52 which may be formed by two separate underlayment sections as illustrated in FIG. 6 or by forming a depression within a single underlayment section. The movement of the projections 50 within the recess 52 provides substantially continuous lateral restraint of the belt along the longitudinal length of the conveyor 10. In this arrangement, the sprockets 30 may be permitted to float longitudinally along the drive shaft.

The skid conveyor described and illustrated herein provides a simple and cost effective transport mechanism for skids as well as numerous specific advantages over the prior art. For example, by indexing the belts 32 and 34 through mechanical engagement with a common sprocketed drive shaft, the present invention provides a pair of positively tracked and parallel drive belts that maintain the skid in proper alignment as it is conveyed along the table. Further, the hard surfaces of the belts provide improved durability and the support provided to the belt by the frame side rails and low friction underlayment provides substantially continuous load distribution both laterally and longitudinally along the conveyor.

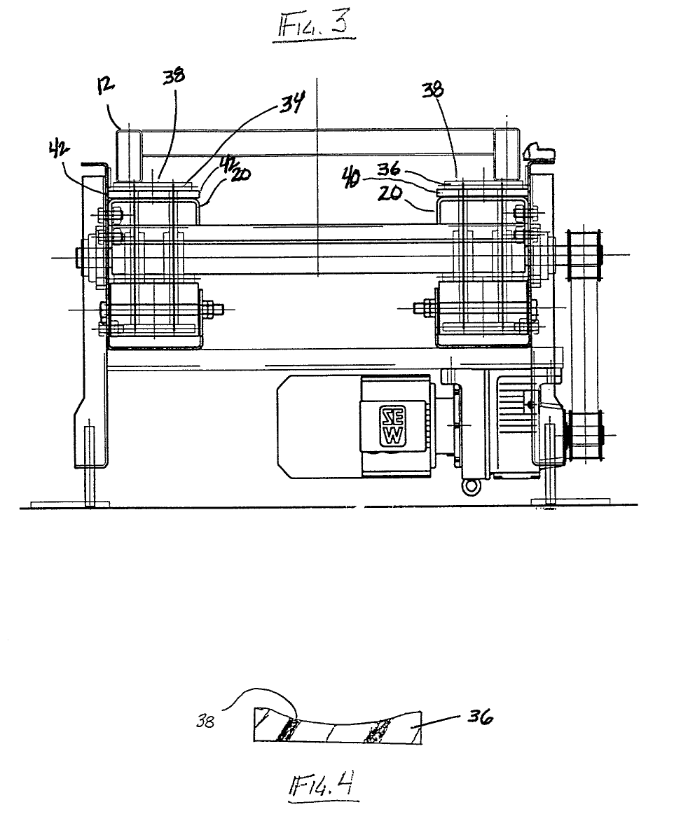

The modular nature of the belt also provides numerous advantages over the prior art. For example, if a portion of the belt is damaged or worn, the damaged portion alone may be removed and replaced with more suitable material. The repair and replacement of damaged sections is further facilitated by the fact that the conveyor does not include a tensioning device for the belt. Any necessary tensioning is provided by the weight of the suspended belt along the return path as generally illustrated in FIG. 2. In contrast to skid conveyors using a plurality of rollers or steel corded rubber belts, the present invention provides stable support and more effective transportation of the skids along the conveyor. Further, the support of the side rail along the lateral extent of the underlayment 40 permits the thickness of the friction reducing underlayment to be reduced and the underlayment to be coupled to the frame by mechanisms that do not deteriorate the performance of the underlayment, such as an adhesive.

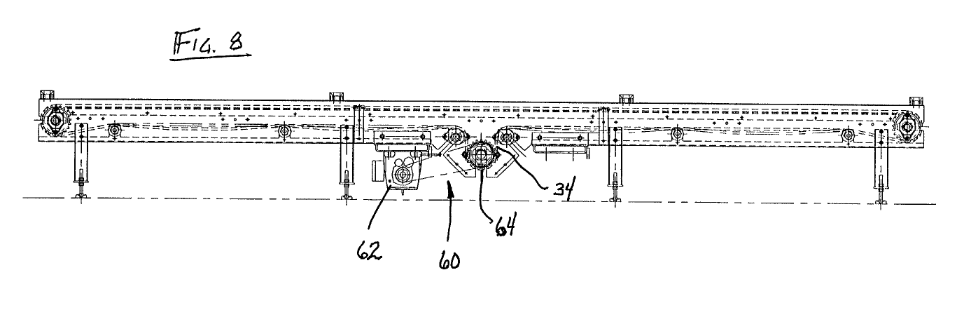

The conveyor of the present invention may include a reversible drive assembly 60 as shown in FIG. 8. The reversible motor 62 is coupled to selectively drive a sprocket 64 in two directions. As is illustrated in FIG. 8, the belts (e.g., belt 34) are passed about the drive sprocket 64 whereby the mechanical engagement of the sprocket teeth and recesses in the bottom surface of the belt transfer bi-directional rotational movement of the sprocket 64 into bi-directional movement of the belts. Locating the reversible motor and sprocket in the center of the conveyor enhances bidirectional belt movement by eliminating pinch points that may inhibit movement of the belts in two directions.

A further advantage of the conveyor 10 with a belt having rigid modules is the ability to incorporate selected components within the belt itself by replacing one or more of the modules 36. The conveyor 10 of the present invention may include an accumulating assembly 70 integrated into the belts 32 and 34 to provide accumulation of skids along the conveyor. Accumulation or buffering of workpieces is desirable in assembly operations to provide a continuous supply of workpieces to downstream operations. The illustrated accumulating assembly 70 includes accumulator support links 72 interspersed with the plastic modules 36. The support links 72 are configured to match or cooperate with the modules 36 to form the belts and coupled by hinge pins or the like for ease of replacement. Mounting flanges 74 are fixed to, and vertically extend from, the links 72. An idler roller 76, such as the illustrated lubricated roller, having a sleeve 78 is rotatable about or with the shaft 80. The rollers 76 are positioned on the belts to support the skid rails. In order to effectively operate under the high loadings present in vehicle assembly operations, the support links, mounting flanges, and rollers are preferably formed of a rigid and strong material such as steel.

The rotating friction in the accumulating assembly is selected so that the skids, with rails riding upon the sleeves 78, are transferred along with the non-rotating sleeves when accumulation is not desired. However, when the skids are accumulated, a stop mechanism such as a retractable arm may engage the skids at a predetermined location along the conveyor 10. When so engaged, the sleeves rotate beneath the stationary skid rails to permit movement of the belt under the skid. The accumulator assembly thereby provides effective accumulation without under wear on the belts. While the specific rotating friction of the sleeves 78 may be varied for a particular application, a friction factor on the order of 0.06 is considered to be appropriate for the illustrated application wherein the friction factor of the belt relative to the underlayment is on the order of 0.10.

Selected modules of the belt may also be replaced with modules having sensing targets that may be used in conjunction with sensing devices and PLC timers to monitor belt speed or track the position of the belt along the conveyor. The position of the skid on the conveyor can be controlled by releasing a skid onto the conveyor based on the position of the sensing target or targets on the belt. This information can be used for a variety of benefits including tracking the position of workpieces along the belt. Those skilled in the art will appreciate that a variety of sensing targets and devices may be used to provide the above benefits. For example, while the sensing targets are described above as being incorporated into selected modules of the belt, the direct indexing of the belt to the drive sprockets permits alternative mechanisms such as the use of photo cells to count teeth or holes on the sprockets as a direct representation of the movement of the belt.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A conveyor comprising:
a frame having first and second laterally spaced side rails;
first and second underlayments fixed to said first and second side rails;
first and second endless belts each formed of a plurality of interconnected rigid modules, said first underlayment supporting said first belt and said second underlayment supporting said second belt; and
a drive mechanically coupled to said first and second belts.

2. The conveyor of claim 1 wherein the friction factor between the belt and underlayment is less than about 0.18.

3. The conveyor of claim 1 wherein said drive includes a drive shaft and first and second sprockets each rotating with said drive shaft and configured to mechanically engage one of said first and second belts to drive said belts.

4. The conveyor of claim 1 wherein said first and second underlayments each have lateral sides and a planar upper surface between said lateral sides, said planar surfaces supporting said first and second belts.

5. The conveyor of claim 1 wherein said first and second underlayments each include lateral sides and a recess between said sides, wherein said first and second belts include a restraining projection extending from a first planar surface, and wherein said restraining projection is disposed in said underlayment recess along said conveying segment to laterally position said belt relative to said underlayment.

6. The conveyor of claim 1 wherein said modules of said first and second belts include a plurality of first modules comprised of a rigid plastic and interconnected by hinge pins.

7. The conveyor of claim 6 wherein said rigid plastic first modules are comprised of polyethylene, polypropylene, or acetal thermoplastics.

8. The conveyor of claim 6 wherein said modules of said first and second belts further include a plurality of accumulator support links coupled to said first modules, said accumulator support links having an accumulating assembly fixed to said support links and including an idler roller having a rolling friction factor approximately equal to a friction factor of the first and second belts.

9. The conveyor of claim 8 wherein said accumulating assembly further includes mounting flanges extending vertically from said support links, a shaft coupled to said flanges, and wherein said idler roller is rotationally coupled to said shaft.

10. The conveyor of claim 9 wherein said accumulating assembly further includes a bearing assembly disposed between said idler roller and said shaft.

11. The conveyor of claim 1 wherein said first and second belts each include an upper engagement surface defining a centering recess.

12. A skid transport system comprising:
a skid adapted to convey a workpiece, said skid having a pair of laterally spaced support rails; and
a conveyor including
a frame having first and second laterally spaced side rails;
first and second underlayments fixed to said first and second side rails;
first and second endless belts each formed of a plurality of interconnected rigid modules, said first underlayment supporting said first belt and said second underlayment supporting said second belt; and
a drive assembly mechanically coupled to said first and second belts to synchronously move said first and second belts.

13. The skid transport system of claim 12 wherein said drive includes a drive shaft and first and second sprockets each rotating with said drive shaft and configured to mechanically engage one of said first and second belts to drive said belts.

14. The skid transport system of claim 12 wherein said first and second underlayments each have lateral sides and a planar upper surface between said lateral sides, said planar surfaces supporting said first and second belts.

15. The skid transport system of claim 12 wherein said rigid plastic first modules are comprised of polyethylene, polypropylene, or acetal thermoplastics.

16. The skid transport system of claim 12 wherein said modules of said first and second belts further include a plurality of accumulator support links coupled to said first modules, said accumulator support links having an accumulating assembly fixed to said support links and including an idler roller having a rolling friction factor approximately equal to a friction factor of the first and second belts.

17. The skid transport system of claim 16 wherein said accumulating assembly further includes mounting flanges extending vertically from said support links, a shaft coupled to said flanges, and wherein said idler roller is rotationally coupled to said shaft.

18. The skid transport system of claim 17 wherein said accumulating assembly further includes a bearing assembly disposed between said idler roller and said shaft.

19. The skid transport support system of claim 12 wherein said drive assembly includes a reversible drive operative in a first mode to move the first and second belts in a first direction and in a second mode to move said first and second belts in a second direction opposite said first direction.

20. The skid transport system of claim 19 wherein said reversible drive is positioned proximate the center of the conveyor.
